(19) United States
(12) Patent Application Publication
(10) Pub. No.: US 2009/0177425 A1
(43) Pub. Date: Jul. 9, 2009

(54) Correction device for acceleration sensor, and output value correction method for acceleration sensor

(76) Inventors: Hisayoshi Sugihara, Aichi-ken (JP); Yutaka Nonomura, Aichi-ken (JP); Motohiro Fujiyoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/989,690

(22) PCT Filed: Aug. 1, 2006
(86) PCT No.: PCT/IB2006/002088

§ 371 Date: Jan. 30, 2008

(30) Foreign Application Priority Data
Aug. 1, 2005 (JP) 2005-223504

(51) Int. Cl. G01P 21/00; G01P 15/00

(52) U.S. Cl. 702/85

(57) ABSTRACT

An attitude angles calculation device (14) calculates attitude angles of a robot from the output values of an acceleration sensor (10). An attitude angles comparison device (16) compares attitude angles in a specified attitude which have been set in a register (20) and the attitude angles which have been detected, and outputs their differences to a correction values calculation device (18). The correction values calculation device (18) outputs correction devices to a zero point correction device (26) or a sensitivity correction device (28), so as to eliminate these differences. If would also be acceptable to set the attitude angles which are set in the register (20) from an input device (22).

### FIELD OF THE INVENTION

The present invention relates to a technique for correcting the output value of an acceleration sensor which is fitted to a mobile body such as a robot or the like.

### BACKGROUND OF THE INVENTION

Acceleration sensors and yaw rate sensors are used for attitude control of a mobile body such as a robot or the like. Taking an X axis, a Y axis, and a Z axis as being three orthogonal axes, then the accelerations in these three axial directions are detected by three acceleration sensors, and the yaw rates around these three axes are detected by three yaw rate sensors. The angles around these axes, i.e. the attitude angles (the roll angle, the pitch angle, and the yaw angle) are obtained by time integrating the outputs of these yaw rate sensors.

In Japanese Patent Publication No. JP-A-2004-268730, there is disclosed a technique for attitude control by using acceleration data and attitude data outputted from a gyro sensor.

An acceleration sensor has a zero point offset, and it is necessary to correct for this zero point offset when the mobile body is stationary; but it is not possible to determine the zero point, since the acceleration due to gravity is present even when stationary. Of course, it would be possible to utilize an acceleration sensor of high accuracy which has zero point stability, but in this case not only does the cost become high, but the size and the weight are both increased as well.

### DISCLOSURE OF THE INVENTION

Thus, the objective of the present invention is to provide a technique which can correct the output value of an acceleration sensor with a simple structure, and which can detect with high accuracy the acceleration, and furthermore the attitude angle, of a mobile body.

A first aspect of the present invention relates to a correction device for an acceleration sensor including: means for calculating attitude angle data of a mobile body, based upon an output value from an acceleration sensor which is provided to the mobile body; and means for correcting the output value of the acceleration sensor, by comparing the attitude angle data with reference attitude angle data.

According to this correction device, attitude angle data of the mobile body such as a robot or the like are calculated from the output values of the acceleration sensor. Reference attitude angles which have been detected separately from the detection by the acceleration sensor of this attitude angle data, or which have been set, and the attitude angle data which have been calculated, are compared together. And, if a zero point offset or a sensitivity anomaly is present in the output values of the acceleration sensor, then the attitude angles which are calculated based upon these output values have values which are different from the reference attitude angle data. Thus, by comparing both of these attitude angle data, it is possible to detect anomalies in the output values of the acceleration sensor, and to correct their amounts. Since, with the above described correction device, it is not the accelerations themselves which have been detected by the acceleration sensors which are compared together, but rather the attitude angle data obtained from the accelerations, accordingly it is possible to perform correction with high accuracy, while not suffering any influence from gravitational acceleration.

According to the present invention, it is possible to correct the output values of the acceleration sensor with a simple structure, and it is possible to detect with high accuracy the acceleration, and furthermore the attitude angles, of a mobile body.

A second aspect of the present invention relates to a method for correcting the output value of an acceleration sensor. This method comprises a step of calculating attitude angle data of a mobile body, based upon an output value from an acceleration sensor; a step of comparing the attitude angle data and reference attitude angle data; and a step of correcting the output value of the acceleration sensor, based upon the result of comparison of the attitude angle data and the reference attitude angle data.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a structural block diagram of an embodiment of the present invention;

FIG. 2 is a structural block diagram of another embodiment;

FIG. 3 is a structural block diagram of yet another embodiment;

FIG. 4 is a flow chart showing the flow of control of correction processing, in an embodiment of the present invention;

FIG. 5 is a figure showing the relationship between a reference coordinate system (XYZ) and a sensor coordinate system (xyz);

FIG. 6 is a figure showing attitude angles (roll angle, pitch angle, and yaw angle) in the reference coordinate system;

FIG. 7 is a figure showing time changes of a sensor coordinate system n;

FIG. 8 is a figure showing minute rotational angles in the sensor coordinate system; and

FIG. 9 is a figure showing tilt angles.

### DETAILED DESCRIPTION OF THE PREFERRED EMBODIMENTS

In the following, embodiments of the present invention will be explained with reference to the drawings.

### First Embodiment

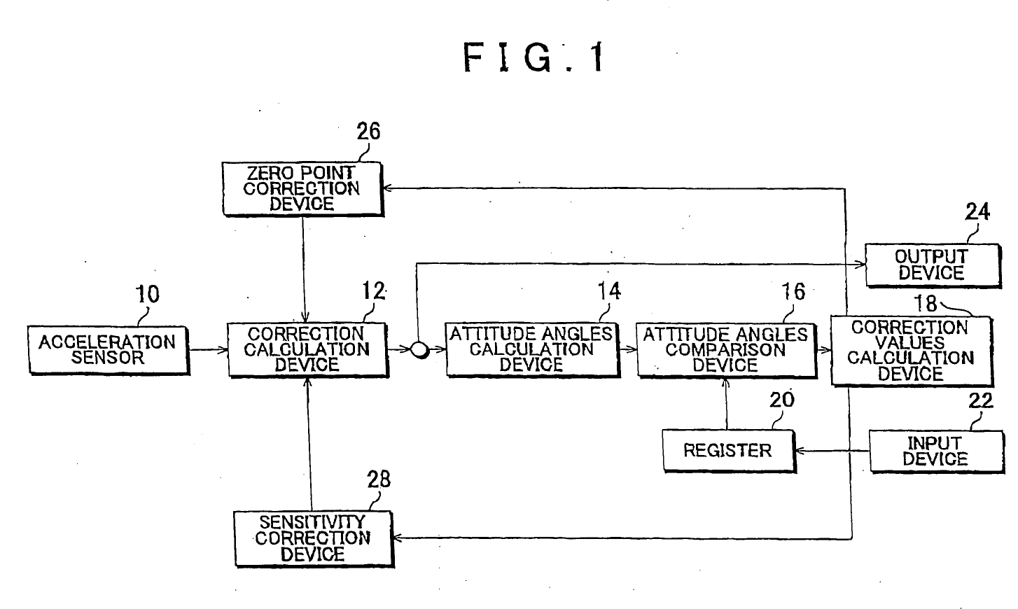

FIG. 1 is a structural block diagram of this first embodiment. An acceleration sensor 10 is provided in a predetermined position, and at a predetermined attitude, upon a mobile body such as a robot or the like, and detects the accelerations of this mobile body and outputs them to a correction calculation device 12.

This correction calculation device 12 corrects the output values of the acceleration sensor 10 based upon correction data from a zero point correction device 26 and from a sensitivity correction device 28 which will be described hereinafter, and outputs the result to an output device 24. Furthermore, the correction calculation device 12 outputs the output values which have been corrected to an attitude angle calculation device 14.

This attitude angle calculation device 14 calculates tilt angles based upon the output values from the correction calculation device 12, calculates an attitude matrix based upon these tilt angles, and calculates the attitude angles of the mobile body based upon this attitude matrix. The calculation of the tilt angles from the accelerations, and the calculation of the attitude angles from the tilt angles, will be described hereinafter. The attitude angle calculation device 14 outputs the attitude angles which it has obtained by this calculation to an attitude angle comparison device 16.

The attitude angle comparison device 16 compares together the attitude angles that have been obtained from the output values (the acceleration attitude angles), and the attitude angles which are set in a register 20 (the reference attitude angles), and makes a decision as to whether or not the differences between them are greater than predetermined permitted values. If the differences between the acceleration attitude angles and the reference attitude angles are greater than or equal to the predetermined permitted values, then it is decided that it is necessary to perform correction of the output values, and the differences between the acceleration attitude angles and the reference attitude angles are outputted to a correction values calculation device 18.

This correction values calculation device 18 calculates, using these differences which have been inputted, the correction values which are required for correcting the zero point and the sensitivity of the output values, outputs the correction value which is required for correcting the zero point of the output values to the zero point correction device 26, and outputs the correction value which is required for correcting the sensitivity of the output values to the sensitivity correction device 28. The zero point correction device 26 outputs to the correction calculation device 12 the zero point offset values which are required for zero point correction by the correction calculation device 12. The correction calculation device 12 corrects the output values by eliminating the zero point offsets from the output values. Furthermore, the sensitivity correction device 28 outputs to the correction calculation device 12 coefficients (gains) which are required for sensitivity correction by the correction calculation device 12. This correction of the output values may only consist of zero point correction by the zero point correction device 26.

The reference attitude angles which are to be compared with the acceleration attitude angles are set in the register 20, as described above. This reference attitude angles which are set in the register 20 are attitude angles when the robot is being maintained in an attitude which is specified in advance, but, provided that the accuracy is ensured, it would also be acceptable to arrange to supply them via an input device 22 from an attitude angle sensor which was provided to the robot separately from the acceleration sensor 10. When comparing the acceleration attitude angles with the reference attitude angles in an attitude which is determined in advance, it will be sufficient for fixed values to be set into the register 20; the input device 22 is not essential. It is possible to utilize an optical fiber gyro (FOG) or the like as a separately provided attitude angle sensor. The attitude angles are detected by time integrating the angular velocities which have been detected by the optical fiber gyro, and these attitude angles are supplied to the input device 22 arid are set into the register 20. The acceleration sensor 10 detects the acceleration in the vertical direction, and, if the robot, which is a mobile body, is stationary while standing up straight, then the reference angles when thus standing up straight are set into the register 20, and are compared with the acceleration attitude angles. If the acceleration sensor 10 accurately outputs “1G”, then the acceleration attitude angles and the reference attitude angles agree with one another within the range of a predetermined permitted values, but if this is not the case, then the output values of the acceleration sensor 10 are corrected according to these differences. If the robot is tilting, a component of the acceleration exists which is not upon the vertical axis; but, by comparing the acceleration attitude angles and the reference attitude angles at this time, it is possible to correct the output values of the acceleration sensor 10.

Although the acceleration attitude angles and the reference attitude angles are compared together in the attitude angles comparison device 16, it would also be acceptable to arrange to compare the tilt angles which have been calculated by the attitude angles calculation device 14 with reference attitude angles which have been set in the register 20, or to arrange to compare the attitude matrix which has been calculated by the attitude angles calculation device 14 with a reference attitude matrix which has been set in the register 20. Moreover, it would also be acceptable for a quaternion of the attitude angles to be calculated by the attitude angles calculation device 14, and for this quaternion to be compared with a reference quaternion which has been set in the register 20. In this embodiment, “attitude data” is used as a generic term for attitude angles, tilt angles, an attitude matrix, or a quaternion.

In the following, a method for calculating the tilt angles from the accelerations, a method for calculating an attitude matrix from the tilt angles, and a method for calculating attitude angles from the attitude matrix, will be explained.

First, the attitude matrix will be explained. In the reference coordinate system XYZ, as a notational system for a sensor coordinate system, this is expressed by an attitude matrix at a discrete time n. The attitude matrix T(n) consists of 4×4 elements, as shown in Equation (1):

$$T ( n ) = ( \begin{matrix}a & d & g & 0 \\ b & e & h & 0 \\ c & f & i & 0 \\ 0 & 0 & 0 & 1\end{matrix} ) \qquad ( 1 )$$

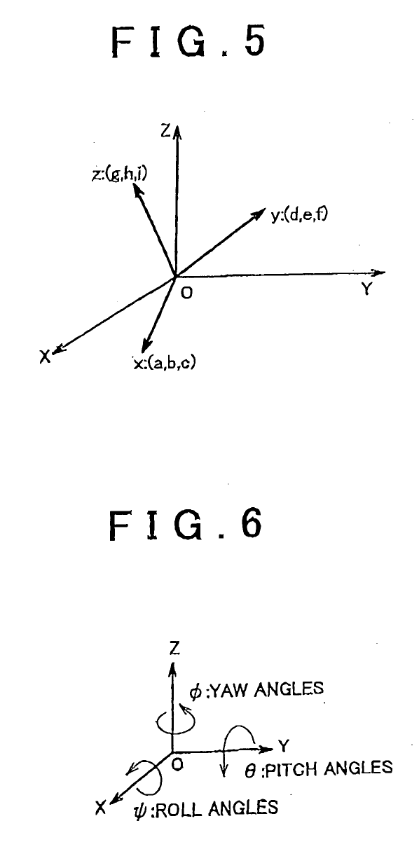

The meaning of this matrix T(n) is that: the first column (a, b, c), the second column (d, e, f), and the third column (g, h, i) are the respective direction vectors of the x axis, the y axis, and the z axis of the sensor coordinate system n as seen from the reference coordinate system. And the fourth column gives the origin position of the sensor coordinate system in the reference coordinate system (generally, if there is a translation, the amount of translation is given in this fourth column). If the origin does not shift, the first through the third elements of the fourth column, which give the conversion of position, are zero. As shown in FIG. 5, the origin On of the sensor coordinate system n is at the position (0, 0, 0) in the reference coordinate system, and the x axis vector has components (a, b, c) in the reference coordinate system, the y axis vector has components (d, e, f) in the reference coordinate system, and the z axis vector has components (g, h, i) in the reference coordinate system.

The technique for obtaining the attitude matrix T(n) from the attitude angles (the roll, pitch, and yaw angles) will now be explained in the following. In rotational conversion according to the matrix for expressing the attitude matrix T(n), it is necessary to consider the order of the rotational axes. As shown in FIG. 6, when using roll, pitch, and yaw angles as are generally used with a robot, it is defined that three rotations have occurred; initially, a rotation Φ around the z axis; next, after that rotation, a rotation θ around the y axis; and finally, after that rotation, a rotation Ψ around the x axis (attention must be paid to the point that the rotation order of the axes is fixed).

The conversion matrix due to the roll, pitch, and yaw angles will be termed RPY(Ψ, θ, Φ). RPY(Ψ, θ, Φ) is the matrix product of the rotation conversion matrixes multiplied from left to right, and is given by Equation (2):

RPY(Φ,θ,Ψ)=Rot(z,Φ)·Rot(y,Φ)·Rot(x,Ψ) (2)

In concrete terms, Equation (2) may be expressed as Equation (3):

$$RPY ( φ , θ , ψ ) = ( \begin{matrix}cos φ & - sin φ & 0 & 0 \\ sin φ & cos φ & 0 & 0 \\ 0 & 0 & 1 & 0 \\ 0 & 0 & 0 & 1\end{matrix} ) ( \begin{matrix}cos θ & 0 & sin θ & 0 \\ 0 & 1 & 0 & 0 \\ - sin θ & 0 & cos θ & 0 \\ 0 & 0 & 0 & 1\end{matrix} ) ( \begin{matrix}1 & 0 & 0 & 0 \\ 0 & cos ψ & - sin ψ & 0 \\ 0 & sin ψ & cos ψ & 0 \\ 0 & 0 & 0 & 1\end{matrix} ) \qquad ( 3 )$$

When Equation (3) is written out at length, Equation (4) results:

$$RPY ( φ , θ , ψ ) = ( \begin{matrix}cos φcos θ & cos φsin θsin ψ - sin φcos ψ & cos φsin θcos ψ + sin φsin ψ & 0 \\ sin φ cos θ & sin φsin θsin ψ + cos φ cos ψ & sin φ sin θcos ψ - cos φ sin ψ & 0 \\ - sin θ & cos θ sin ψ & cos θcos ψ & 0 \\ 0 & 0 & 0 & 1\end{matrix} ) \qquad ( 4 )$$

It should be understood that, instead of the roll, pitch, and yaw angles, it would also be possible to utilize the Euler angles as the attitude angles. With Euler angles, the conversion matrix when initially a rotation Φ around the z axis, next, after that rotation, a rotation θ around the y axis, and finally, after that rotation, a rotation Ψ around the z axis have occurred is expressed as Euler(EΦ, Eθ, EΨ), and is given by Equation (5):

Euler(EΦ,Eθ,EΨ)=Rot(z,EΦ)·Rot(y,Eθ)·Rot(z,EΨ) (5)

In concrete terms, Equation (5) may be expressed as Equation (6):

$$Euler ( E φ , E θ , E ψ ) = ( \begin{matrix}cos E φ & - sin E φ & 0 & 0 \\ sin E φ & cos E φ & 0 & 0 \\ 0 & 0 & 1 & 0 \\ 0 & 0 & 0 & 1\end{matrix} ) ( \begin{matrix}cos E θ & 0 & sin θ & 0 \\ 0 & 1 & 0 & 0 \\ - sin E θ & 0 & cos θ & 0 \\ 0 & 0 & 0 & 1\end{matrix} ) ( \begin{matrix}cos E ψ & - sin E ψ & 0 & 0 \\ sin E ψ & cos E ψ & 0 & 0 \\ 0 & 0 & 1 & 0 \\ 0 & 0 & 0 & 1\end{matrix} ) \qquad ( 6 )$$

When Equation (6) is written out at length, Equation (7) results:

$$Euler ( E φ , E θ , E ψ ) = ( \begin{matrix}cos E φ cos E θ cos E ψ - & - cos E φcos E θ sin E ψ - & cos E φ sin E θ & 0 \\ sin E φsin E ψ & sin E φ cos E ψ & & \\ sin E φ cos E θ cos E ψ + & - sin E φcos E θsin E ψ + & sin E φ sin E θ & 0 \\ cos E φsin E ψ & cos E φcos E ψ & & \\ - sin E θcos E φ & sin E θsin E ψ & cos E θ & 0 \\ 0 & 0 & 0 & 1\end{matrix} ) \qquad ( 7 )$$

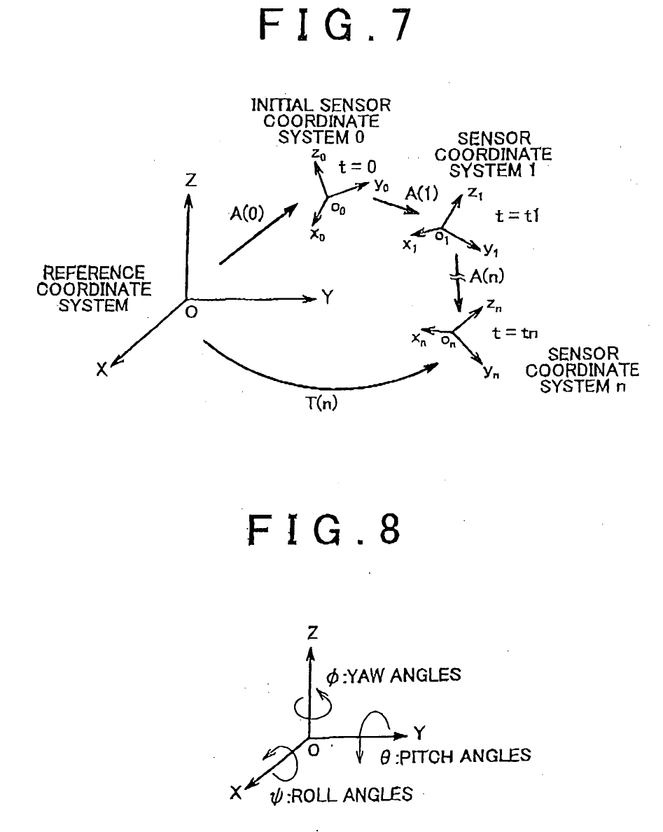

The reference coordinate system is taken as O-XYZ, and the initial sensor coordinate system is taken as being Oₒ-xₒyₒzₒ. The coordinate conversion A(0) makes the connection between the reference coordinate system and the coordinate system Oₒ-xₒyₒzₒ at the time instant t=0. The coordinate system at the time instant t=tₙ is taken as being Oₙ-xₙyₙzₙ. And it is supposed that the origin of this coordinate systems does not shift, so that they are the same. Thereafter when, due to change of the attitude of the mobile body, as shown in FIG. 7, the coordinate system has changed from O₍ₙ₋₁₎-x₍ₙ₋₁₎y₍ₙ₋₁₎z₍ₙ₋₁₎ to Oₙ-xₙyₙzₙ, then O₍ₙ₋₁₎-x₍ₙ₋₁₎y₍ₙ₋₁₎z₍ₙ₋₁₎ and Oₙ-xₙyₙzₙ are in a relationship given by the matrix A(n) obtained from the output values. The sensor coordinate system T(n) as seen from the reference coordinate system is obtained by Equation (8), by applying the conversions A(n) in sequence from the right. When the origin of the sensor coordinate system shifts with time, then the coordinates which have changed with time are sequentially inserted into the first through the third element of the fourth column of the matrix A. This fourth column of the matrix A will not be particularly discussed herein, since it experiences no influence due to the rotation of the sensor coordinate system.

T(n)=A(0)A(1). . . . A(n−1)A(n) (8)

Next, the method for deriving a minute rotation matrix A(n) from the angular velocity output values of an optical fiber gyro or the like with be explained. Three angular velocity sensors are set up on the various axes of the sensor coordinate system, and, as shown in FIG. 8, they measure the angular velocities around the sensor x, y, and z axes. When, in Equation (4), the rotational angles ΔΦ, Δθ, and ΔΨ are sufficiently small, then it is the case that:

sin≈0 (9)

cos≈1 (10)

Due to this, it is possible to express Equation (11), using the minute rotational angle ΔΦ around the sensor z axis, the minute rotational angle Δθ around the sensor y axis, and the minute rotational angle ΔΨ around the sensor x axis. Since, as the result of Equation (11), each of the elements of the matrix consists of an independent minute rotational angle, approximately, there is no dependence upon the order of the rotations.

$$A ( i ) = ( \begin{matrix}1 & - Δφ & Δθ & 0 \\ Δφ & 1 & - Δψ & 0 \\ - Δθ & Δψ & 1 & 0 \\ 0 & 0 & 0 & 1\end{matrix} ) \qquad ( 11 )$$

Between the minute angles and the output values, the minute rotational angles ΔΦ, Δθ, and ΔΨ, the output values ωx, ωy, and ωz from the angular velocity sensors, and the sampling cycle tₛ, there are the relationships given by Equations (12) through (14). Since the sampling cycle tₛ is taken as being a cycle which is sufficiently quick with respect to the rotational movement, accordingly the rotations are sufficiently small within the time of the sampling cycle tₛ, and may be considered as minute rotational angles.

ΔΦ=ω_{z}·tₛ (12)

Δθ=ω_{y}·tₛ (13)

ΔΨ=ωₓ·tₛ (14)

Due to this, the matrix A(n) is given by Equation (15):

$$A ( n ) = ( \begin{matrix}1 & - {ω}_{x} \cdot {t}_{s} & {ω}_{y} \cdot {t}_{s} & 0 \\ {ω}_{x} \cdot {t}_{s} & 1 & - {ω}_{z} \cdot {t}_{s} & 0 \\ - {ω}_{y} \cdot {t}_{s} & {ω}_{z} \cdot {t}_{s} & 1 & 0 \\ 0 & 0 & 0 & 1\end{matrix} ) \qquad ( 15 )$$

Next, a technique for obtaining the attitude angles from the attitude matrix will be described.

The attitude matrix T(n) is given by Equation (16):

$$T ( n ) = ( \begin{matrix}a & d & g & 0 \\ b & e & h & 0 \\ c & f & i & 0 \\ 0 & 0 & 0 & 1\end{matrix} ) \qquad ( 16 )$$

The yaw angle Φ is:

Φ=a tan 2(b,a) (17)

The domain of the yaw angle Φ, which is an attitude angle, is −π<Φ≦π.

The pitch angle θ is:

θ=a tan 2(−c, cos Φ·a+sin Φ·b) (18)

The domain of the pitch angle θ, which is an attitude angle, is −π/2≦θ≦π/2.

The roll angle Ψ is:

Ψ=a tan 2(sin Φ·g−cos Φ·h,−sin Φ·d+cos Φ·e) (19)

The domain of the roll angle Ψ, which is an attitude angle, is −90 <Ψ≦π.

If Euler angles are used, then Equations (20) through (23) are employed:

$$T ( n ) = ( \begin{matrix}a & d & g & 0 \\ b & e & h & 0 \\ c & f & i & 0 \\ 0 & 0 & 0 & 1\end{matrix} ) \qquad ( 20 )$$

EΦ=a tan 2(b,a) (21)

Eθ=a tan 2(cos Φ·g+sin Φ·h,i) (22)

EΨ=a tan 2(−sin Φ·a+cos Φ·b,−sin Φ·d+cos Φ·e) (23)

Next, the matrix normalization will be explained.

$$T ( n ) = ( \begin{matrix}a & d & g & 0 \\ b & e & h & 0 \\ c & f & i & 0 \\ 0 & 0 & 0 & 1\end{matrix} ) \qquad ( 24 )$$

Since, after the calculation, each column of the attitude matrix T(n) is sometimes not a unit vector, accordingly normalization is performed upon the attitude matrix with Equation (25), so that the size of each column vector in Equation (24) becomes 1.

$$Normalized [ T ] = ( \begin{matrix}{p}_{1} a & {p}_{2} d & {p}_{1} {bp}_{2} f - {p}_{1} {cp}_{2} e & 0 \\ {p}_{1} b & {p}_{2} e & {p}_{1} {cp}_{2} d - {p}_{1} {ap}_{2} f & 0 \\ {p}_{1} c & {p}_{2} f & {p}_{1} {ap}_{2} e - {p}_{1} {bp}_{2} d & 0 \\ 0 & 0 & 0 & 1\end{matrix} ) \qquad ( 25 )$$

Here, p₁ and p₂ are given by Equations (26) and (27).

$$\begin{matrix}{p}_{1} = \frac{1}{\sqrt{{a}^{2} + {b}^{2} + {c}^{2}}} & ( 26 ) \\ {p}_{2} = \frac{1}{\sqrt{{d}^{2} + {e}^{2} + {f}^{2}}} & ( 27 )\end{matrix}$$

When the elements are viewed after normalization, T(n) becomes:

$$T ( n ) = ( \begin{matrix}a & d & g & 0 \\ b & e & h & 0 \\ c & f & i & 0 \\ 0 & 0 & 0 & 1\end{matrix} ) \qquad ( 28 )$$

Now, the olthogonalization of the matrix will be explained.

$$T ( n ) = ( \begin{matrix}a & d & g & 0 \\ b & e & h & 0 \\ c & f & i & 0 \\ 0 & 0 & 0 & 1\end{matrix} ) \qquad ( 29 )$$

Since, with the attitude matrix T(n), after the calculation, the columns of the attitude matrix sometimes are not orthogonal axes, accordingly orthogonalization processing is performed, so that the vectors are made to be orthogonal (in this case, the z axis is taken as a reference). In order to obtain a new x′ axis which is orthogonal to the z axis and the y axis, a′, b′, and c′ are obtained:

a′=ei−fh (30)

b′=fg−di (31)

c′=dh−eg (32)

Next, in order to obtain a new y′ axis which is orthogonal to the z axis and the x′ axis, d′, e′, and f′ are obtained:

d′=hc′−ib′ (33)

e′=ia′−gc′ (34)

f′=gb′−ha′ (35)

An orthogonalized attitude matrix T(n) is derived from this a′ through f′ which have been obtained:

$$T ( n ) = ( \begin{matrix}{a}^{′} & {d}^{′} & g & 0 \\ {b}^{′} & {e}^{′} & h & 0 \\ {c}^{′} & {f}^{′} & i & 0 \\ 0 & 0 & 0 & 1\end{matrix} ) \qquad ( 36 )$$

J Now, the function atan2 will be explained. atan2(y,x) is a function for a computer, having two variables x and y. Its range of applicability is wider than that of the atan function which is normally used.

ξ=a tan 2(y,x) (37)

(−90 <ξ≦π)

When x>0 and y>0, then

ξ=tan⁻¹(y/x) (38)

When x>0 and y<0, then

ξ=tan⁻¹(y/x) (39)

In the same manner:
When x<0 and y>0, then

ξ=π+tan⁻¹(y/x)

And, when x<0 and y<0, then

ξ=−π+tan⁻¹(y/x)

When x=0 and y>0, then

ξ=π/2

When x=0 and y<0, then

ξ=−π/2

When x=0 and y=0, then

ξ=0

Next, the calculation of the tilt angles will be explained. This is a method for calculating the tilt angles with the attitude angles calculation device 14, based upon the accelerations from the acceleration sensor 10. The tilt angles are the angles λx, λy, and λz between the sensor x, y, and z axes and the reference Z axis. In other words,

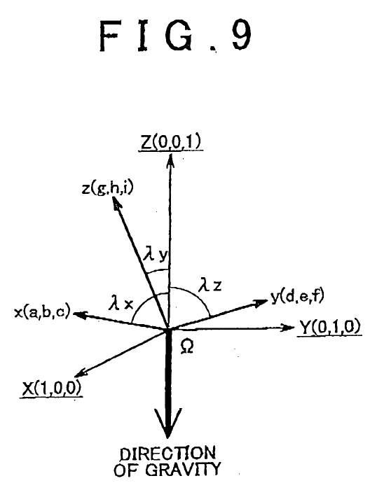

λx is the angle between the x axis and the Z axis;
λy is the angle between the y axis and the Z axis; and
λz is the angle between the z axis and the Z axis.
The range of λx, λy, and λz is 0≦(λx, λy, λz)≦π. FIG. 9 shows the tilt angles and the gravity vector. The tilt angles are obtained, as described below, from the acceleration sensor which is arranged along the sensor coordinates. The accelerations Gx, Gy, Gz are normalized using Equations (40) through (42), and thereby the accelerations after normalization Gx′, Gy′, Gz′ are obtained.

$$\begin{matrix}{G}_{x}^{′} = \frac{{G}_{x}}{\sqrt{{G}_{x}^{2} + {G}_{y}^{2} + {G}_{z}^{2}}} & ( 40 ) \\ {G}_{y}^{′} = \frac{{G}_{y}}{\sqrt{{G}_{x}^{2} + {G}_{y}^{2} + {G}_{z}^{2}}} & ( 41 ) \\ {G}_{z}^{′} = \frac{{G}_{z}}{\sqrt{{G}_{x}^{2} + {G}_{y}^{2} + {G}_{z}^{2}}} & ( 42 )\end{matrix}$$

The tilt angles λx, λy, λz are obtained from the accelerations. Gx, Gy, Gz by using Equations (43) through (45):

λₓ=Arccos(−Gₓ′) (43)

λ=Arccos(−G_{y}′) (44)

λ_{z}=Arccos(−G₂′) (45)

Next, the technique for obtaining the attitude matrix T(n) from the tilt angles λx, λy, λz will be described. The attitude matrix is obtained by the attitude angles calculation device 14 by calculation, based upon the tilt angles.

c=cos(λx) (46)

a=+√(1−c2) (47)

b=0 (48)

f=cos(λy) (49)

d=−c f/a (50)

e=+√(1−f2−2) (where 0≦λz<π/2) (51)

e=−√(1−f2−2) (where π/2<λz≦π) (52)

e=0 (where λz=π/2) (53)

g=−c e (54)

h=c d−a f (55)

i=a e (56)

The attitude matrix T(n) is obtained from the above results.

It should be understood that, when obtaining the tilt angles λx, λy, and λz from the attitude matrix T(n), the following Equations are employed:

$$\begin{matrix}T ( n ) = ( \begin{matrix}a & d & g & 0 \\ b & e & h & 0 \\ c & f & i & 0 \\ 0 & 0 & 0 & 1\end{matrix} ) & ( 57 ) \\ λ x = a cos ( c ) & ( 58 ) \\ λ y = a cos ( f ) & ( 59 ) \\ λ z = a cos ( i ) & ( 60 )\end{matrix}$$

In this manner; with this embodiment, it is possible to correct the output values of the acceleration sensor in a simple manner, by comparing the attitude angles which have been obtained by the acceleration sensor 10 with the reference attitude angles which have been obtained with a separately provided attitude angles sensor.

### Second Embodiment

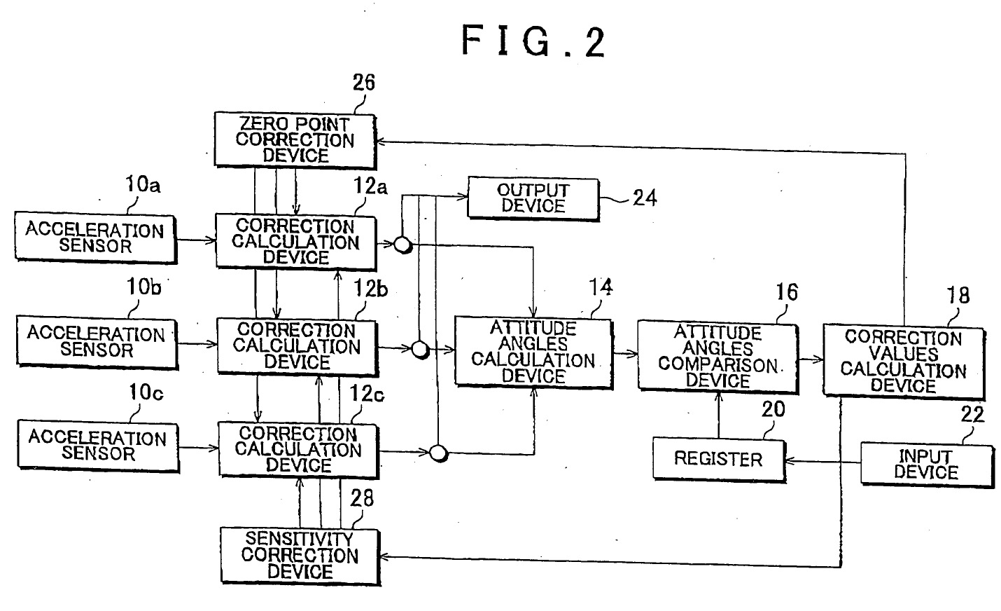

FIG. 2 is a structural block diagram of this second embodiment. The points of difference from FIG. 1 are that three acceleration sensors 10a, 10b, 10c are provided as the acceleration sensor 10, and these detect accelerations in the directions along the three axes x, y, and z; and, moreover, that three correction calculation devices 12a, 12b, 12c are provided corresponding to these acceleration sensors 10a, 10b, 10c respectively.

The accelerations are detected by these three acceleration sensors 10a, 10b, 10c, and it is possible to specify the attitude of the mobile body uniquely by calculating the attitude angles from the output values thereof. Specified attitudes are implemented in sequence while changing the attitude of the mobile body, and the attitude angles which have been detected in these specified attitudes are compared with reference attitude angles which have been set in the register 20. For example, the attitude of the robot may be changed in sequence, so that the x axis, the y axis, and the z axis face, in sequence, in the Z axis direction (i.e. in the vertical direction), and the output values of the acceleration sensors 10a, 10b, 10c may be corrected in sequence, using the differences between the acceleration attitude angles at these times and the reference attitude angles. It would be possible to provide, not just the acceleration sensors 10a and 10b, but, in general, a plurality of n acceleration sensors (where n≦2).

It should be understood that, for convenience, in the drawing, a correction signal from the zero point correction device 26 is only shown as being outputted to the correction calculation device 12a, but it might also be outputted to the other correction calculation devices 12b and 12c. The same holds for the sensitivity correction device 28.

### Third Embodiment

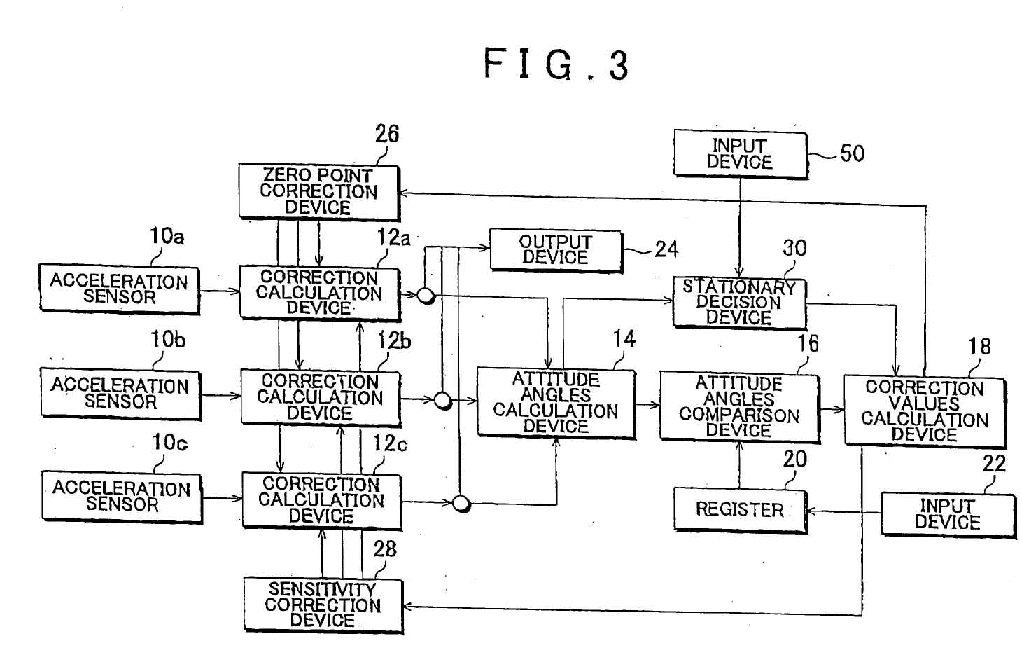

FIG. 3 shows the structure of this third embodiment. In the embodiments described above, the correction of the output values was performed while the robot was stationary in a specified attitude. Accordingly in the case of, for example, a structure in which correction devices of the acceleration sensors perform correction according to commands via an input device 50 from the user or the main processor of the robot, it is necessary to make a decision, when a correction execution command has been received, as to whether or not this is a timing at which the robot is stationary, so that it is possible to perform correction. Thus, upon receipt of a correction execution command from the exterior, the stationary decision device 30 in FIG. 3 makes a decision as to whether or not the robot is in a stationary state.

The stationary decision device 30 detects the amounts of change of the attitude angles from the attitude angles calculation device 14, and decides whether or not these amounts of change are less than or equal to predetermined values. If the amounts of change of the attitude angles are less than or equal to the predetermined values, then it is decided that the robot is in the stationary state, and a correction permit signal is outputted to the correction values calculation device 18. The correction values calculation device 18 calculates correction values by receiving this correction permit signal, and outputs it to the zero point correction device 26 and so on. It would also be acceptable not to arrange for the stationary decision device 30 to detect the amounts of change of the attitude angles, but to arrange to detect the amounts of change of the output values from the acceleration sensor 10 itself, and to compare these amounts of change with predetermined values, and thus to make the decision about the stationary state. If the robot is not stationary but is moving, then the translational acceleration and the centrifugal acceleration are superimposed upon one another, and moreover the accuracy of the correction decreases remarkably, since the output values which are to be corrected change over time. It is possible to ensure the accuracy of the correction by performing the correction of the output values while the robot is in a stationary state.

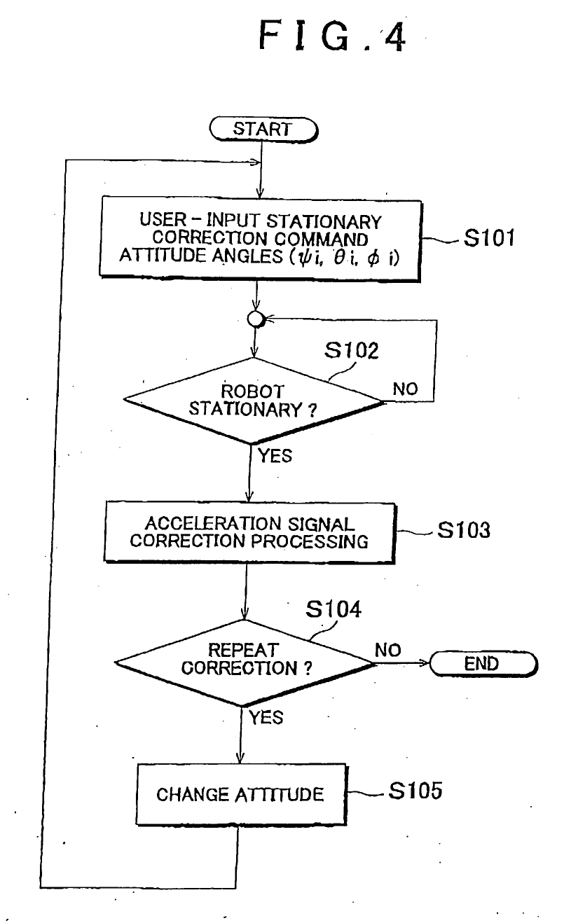

FIG. 4 is a flow chart showing the processing of this embodiment. First, a correction command is inputted from the user (or from a main processor which has received a command from the user), and a roll angle Ψi, a pitch angle θi and a yaw angle Φi are inputted (in a step S101) as the reference attitude angles. These reference attitude angles (Ψi, θi, Φi) which have been inputted by the user or upon his command are set into the register 20. The stationary decision device 30, upon receipt of this correction command, detects the output values of the acceleration sensors 10a, 10b, 10c, or the amounts of change (the time fluctuation widths) of the attitude angles from the attitude angles calculation devices 12a, 12b, 12c, and makes a decision (in a step S102) as to whether or not they are less than predetermined values. If these amounts, of change are less than or equal to the predetermined values, then the stationary decision device 30 decides that the robot is in the stationary state. It should be understood that it would also be acceptable to compare the time period that the amounts of change are less than or equal to the predetermined values with a predetermined threshold time period, and to decide that the robot is in the stationary state, only if the time period is greater than or equal to the predetermined threshold time period. This predetermined threshold time period may, for example, be set to three seconds, and thereby it is possible to detect the required stationary state which is meaningful for correction.

If it has been decided by the stationary decision device 30 that the robot is in the stationary state, then the stationary decision device 30 outputs the correction permit signal, as described above, to the correction values calculation device 18. And, upon this correction permit signal, based upon the differences between the acceleration attitude angles at this time and the reference attitude angles, the correction values calculation device 18 calculates and outputs a correction values so that this difference is decreased or eliminated. The correction calculation devices 12a, 12b, 12c perform (in a step S103) zero point correction or sensitivity correction of the output values by using these correction values.

Next, a decision is made (in a step S104) as to whether or not to repeat the correction, and, if it is necessary to perform the correction a plurality of times, then the attitude of the robot is changed (in a step S105), and the reference attitude angles (Ψj, θj, Φj) are input again, and the same correction processing is performed. It is appropriate to perform correction for all of the three acceleration sensors 10a, 10b, 10c, and, in this case, the correction processing is repeated at least three times. For example, in the attitude (0,0,0), sensitivity correction is performed for the acceleration sensor 10c in the z axis direction; next, in the attitude (π/4,0,0), sensitivity correction is performed for the acceleration sensor 10a in the y axis direction; and, finally, in the attitude (0,π/4, 0), sensitivity correction is performed for the acceleration sensor 10b in the x axis direction. With three acceleration sensors, if sufficient accuracy can be obtained by performing correction for the two acceleration sensors (10a, 10b) in the x axis direction and in the y axis direction, even though correction for the z axis direction is not performed, then it would also be acceptable to perform correction only twice. This presupposes a case in which the attitude of the robot is not greatly inclined, and so on.

In the illustrated embodiment, the controllers are implemented with general purpose processors. It will be appreciated by those skilled in the art that the controllers can be implemented using a single special purpose integrated circuit (e.g., ASIC) having a main or central processor section for overall, system-level control, and separate sections dedicated to performing various different specific computations, functions and other processes under control of the central processor section. The controllers can be a plurality of separate dedicated or programmable integrated or other electronic circuits or devices (e.g., hardwired electronic or logic circuits such as discrete element circuits, or programmable logic devices such as PLDs, PLAs, PALs or the like). The controllers can be suitably programmed for use with a general purpose computer, e.g., a microprocessor, microcontroller or other processor device (CPU or MPU), either alone or in conjunction with one or more peripheral (e.g., integrated circuit) data and signal processing devices. In general, any device or assembly of devices on which a finite state machine capable of implementing the procedures described herein can be used as the controllers. A distributed processing architecture can be used for maximum data/signal processing capability and speed.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

1-10. (canceled)

11. A correction device for an acceleration sensor, comprising:
calculating means for calculating attitude angle data of a mobile body, based upon an output value from an acceleration sensor which is provided to the mobile body;
correcting means for correcting the output value of the acceleration sensor, by comparing the attitude angle data with reference attitude angle data; and
detecting means for detecting a stationary state of the mobile body according to whether the amount of change of the output value of the acceleration sensor, or of the attitude angle data from the calculating means, is less than or equal to a predetermined value, or according to whether the amount of change of the attitude angle data from the calculating means, is less than or equal to a predetermined value,
wherein the correcting means corrects the output value in the stationary state.

12. The correction device according to claim 11, further comprising setting means for setting the reference attitude angle as an attitude angle when the mobile body is in a specified attitude.

13. The correction device according to claim 11, wherein:
a plurality of n (where N≧2) of the acceleration sensors are provided; and
the correcting means corrects the output values for n different specified attitudes of the mobile body.

14. The correction device for an acceleration sensor according to claim 11, further comprising inputting means for inputting a correction command signal for correcting the output value, and wherein the detecting means detects the stationary state when the correction command signal has been inputted.

15. The correction device according to claim 11, wherein the correcting means corrects at least one of a zero point and a sensitivity of the output value.

16. A method of correcting the output value of an acceleration sensor, comprising:
detecting a stationary state of the mobile body according to whether the amount of change of the output value of the acceleration sensor, or of the attitude angle data from the calculating means, is less than or equal to a predetermined value, or according to whether the amount of change of the attitude angle data from the calculating means, is less than or equal to a predetermined value, and in case the stationary state is detected:
calculating attitude angle data of a mobile body, based upon an output value from an acceleration sensor;
comparing the attitude angle data and reference attitude angle data; and
correcting the output value of the acceleration sensor, based upon the result of comparison of the attitude angle data and the reference attitude angle data.

17. A correction device for an acceleration sensor, comprising:
a calculating device that calculates attitude angle data of a mobile body, based upon an output value from an acceleration sensor which is provided to the mobile body;
a correcting device that corrects the output value of the acceleration sensor, by comparing the attitude angle data with reference attitude angle data; and
a detecting device that detects a stationary state of the mobile body according to whether the amount of change of the output value of the acceleration sensor, or of the attitude angle data from the calculating device, is less than or equal to a predetermined value, or according to whether the amount of change of the attitude angle data from the calculating device, is less than or equal to a predetermined value,
wherein the correcting device corrects the output value in the stationary state.

18. The correction device according to claim 17, further comprising a setting device that sets the reference attitude angle as an attitude angle when the mobile body is in a specified attitude.

19. The correction device according to claim 17, wherein:
a plurality of n (where n≧2) of the acceleration sensors are provided; and
the correcting device corrects the output values for n different specified attitudes of the mobile body.

20. The correction device for an acceleration sensor according to claim 17, further comprising an inputting device that inputs a correction command signal for correcting the output value, and wherein the detecting device detects the stationary state when the correction command signal has been inputted.

21. The correction device according to claim 17, wherein the correcting means corrects at least one of a zero point and a sensitivity of the output value.
